(19) United States
(12) Patent Application Publication
(10) Pub. No.: US 2026/0117838 A1
(43) Pub. Date: Apr. 30, 2026

(54) BOTTOM VALVE FOR A TELESCOPIC DAMPER AND TELESCOPIC DAMPER

(71) Applicant: ZF Friedrichshafen AG, Friedrichshafen (DE)

(72) Inventors: Manuel Treubert, Oberthulba (DE); Steffen Siegler, Zellingen (DE)

(73) Assignee: ZF Friedrichshafen AG, Friedrichshafen (DE)

(21) Appl. No.: 19/009,080

(22) Filed: Jan. 3, 2025

(30) Foreign Application Priority Data
Jan. 11, 2024 (DE) 102024200236.4

(51) Int. Cl. F16F 9/348; F16F 9/18

(52) U.S. Cl. CPC F16F 9/348; F16F 9/185; F16F 2222/12

(57) ABSTRACT

A bottom valve having a valve body with first and second sides and configured in an installed state in a telescoping damper to separate a work chamber on the first side from a portion of an equalization space on the second side. A restriction bore formed in the valve body allows a respective fluid flow from the first side in direction of the second side while a respective opposite fluid flow is prevented. A separating element is provided which, together with the valve body, defines an intermediate space bounded at least at a respective orifice of the restriction bore facing the second side of the valve body and is delimited from an equalization region in which the portion of the equalization space is provided in the installed state of the base valve. Fluid can be exchanged via at least one passage between the intermediate space and the equalization region.

### BACKGROUND OF THE INVENTION

### 1. Field of the Invention

The invention is directed to a bottom valve, also referred to as a “base valve” for a telescoping damper comprising a valve body with a first side and a second side, which valve body is configured in an installed state of the base valve in the telescoping damper to separate a work chamber of the telescoping damper located on the first side from a portion of an equalization space of the telescoping damper located on the second side. At least one restriction bore is formed in the valve body via which only a respective fluid flow in direction of the second side can be enabled, while a respective opposite fluid flow in direction of the first side via the at least one restriction bore is prevented, and a separating element is provided which, jointly with the valve body, defines at least one intermediate space. The invention is further directed to a telescoping damper with an aforementioned base valve.

### 2. Description of the Related Art

The use of telescoping dampers which are usually constructed as mono-tube dampers or as twin-tube dampers is known in chassis of motor vehicles. In a twin-tube damper, a work cylinder is usually received in a surrounding reservoir tube. The work cylinder and reservoir tube define an intermediate, predominantly annular equalization space. A work piston which divides an interior space of the work cylinder into two work chambers and is connected to a piston rod is displaceably guided in the work cylinder. The piston rod is guided out of the work cylinder and reservoir tube and usually forms an attachment point of the twin-tube damper, while a further attachment point opposite the latter is formed at the reservoir tube. In a rebound stage of the twin-tube damper, i.e., when the twin-tube damper pulls apart, a damping is usually realized substantially via a piston valve with which the work piston is outfitted. The piston valve poses a resistance against a fluid flowing between the work chambers via the piston valve so that an upward movement of the piston is braked. Conversely, in the rebound stage, a virtually unimpeded flow of fluid from the equalization space into the interior of the work cylinder is enabled via a base valve which divides the interior of the work cylinder from the interior of the equalization space in the region of the reservoir tube. In a compression stage of the twin-tube damper, i.e., when the twin-tube damper presses together, a damping is generated at least partially by the base valve which poses a resistance to a displacement of fluid from the interior of the work cylinder into the equalization space, while a lower flow resistance is usually generated via the piston valve.

DE 10 2019 212 964 A1 discloses a telescoping damper with a base valve which is arranged at one end of a work cylinder of the telescoping damper. The base valve has a valve body which divides a work chamber of the work cylinder from an equalization space which is formed between the work cylinder and a surrounding reservoir tube. A plurality of through-openings in the form of bore holes and restriction bores are inserted in the valve body. A flow of fluid from the side of the valve body facing the equalization space to the side facing the work chamber can take place via the bore holes, while a flow in the opposite direction via the bore holes is prevented by a cover disk. Conversely, the restriction bores only allow a restricted fluid flow from the side facing the work chamber into the equalization space, spring disks which prevent an opposite fluid flow via the restriction bores being provided at orifices of the restriction bores on the equalization space side. On the work chamber side, the base valve is further outfitted with a movable separating element which, together with the valve body, defines an intermediate space. Through-openings are also formed at the separating element and, further, a gap for a passage for fluid is defined via the separating element in combination with the valve body. The base valve should make possible expanded configuration possibilities in adapting damping characteristics.

Proceeding from the prior art described above, it is the object of the present invention to provide a base valve via which a noise reduction can be achieved in the compression stage when used in a telescoping damper.

### SUMMARY OF THE INVENTION

According to a disclosed embodiment, a base valve comprises a valve body with a first side and a second side. The valve body is configured in an installed state of the base valve in the telescoping damper to separate a work chamber of the telescoping damper located on the first side from a portion of an equalization space of the telescoping damper located on the second side. At least one restriction bore is formed in the valve body via which only a respective fluid flow from the first side of the valve body in direction of the second side can be enabled, while a respective opposite fluid flow via the at least one restriction bore is prevented. Further, a separating element is provided which, together with the valve body, defines an intermediate space.

Accordingly, the valve body of the base valve according to the invention is configured to divide a work chamber from an equalization space, i.e., to spatially separate them from one another, in the installed state of the base valve in a telescoping damper. To this extent, the base valve is provided for use in a twin-tube damper. This division or separation of the spaces is effected in that the valve body is placed between the spaces in the installed state of the base valve in the telescoping damper and can accordingly by itself bring about the division or separation. The valve body of the base valve is preferably designed for fastening to a tube end of a work cylinder of the telescoping damper.

There is formed in the valve body at least one restriction bore via which a fluid flow can take place from the first side in direction of the second side, while a fluid flow in the opposite direction via the at least one restriction bore is prevented. The at least one restriction bore penetrates the valve body, preferably axially, for this purpose. Further, the at least one restriction bore is configured in such a way particularly with respect to its geometry that a restriction of the fluid flow takes place when guided from the first side in direction of the second side of the valve body. Further, a pre-restriction can be carried out at a respective orifice of the at least one restriction bore at the first side of the valve body and can be realized particularly in the form of a restriction disk. In a particularly preferable manner, a plurality of restriction bores via which fluid flows which are parallel to one another can be enabled in direction of the second side are formed in the valve body. In particular, the fluid is oil with which the telescoping damper is filled.

By “axial” is meant in the context of the base valve an orientation parallel to an axis which is located parallel to, or even congruent with, a longitudinal center axis of the chassis vibration damper in the installed state of the chassis vibration damper valve. The base valve is preferably configured to be substantially rotationally symmetrical so that the axis is a rotational axis of the base valve. Within the meaning of the invention, “radial” means an orientation in diameter direction of a respective component part.

Together with a separating element, the valve body defines an intermediate space, i.e., the intermediate space is enclosed between the valve body and the separating element. The separating element is preferably provided as a component part which is separate from the valve body so that the intermediate space can be defined by these two separate component parts in a simple manner. However, within the scope of the invention, the valve body and the separating element could also possibly be formed integrally.

The disclosure includes the technical teaching that the at least one intermediate space is limited at least at a respective orifice of the at least one restriction bore facing the second side of the valve body and is delimited from an equalization region in which the portion of the equalization space is provided in the installed state of the base valve in the telescoping damper. Fluid can be exchanged via at least one passage between the at least one intermediate space and the equalization region.

In other words, the at least one intermediate space is enclosed on the second side of the valve body jointly by the valve body and the separating element, and the at least one restriction bore opens into the at least one intermediate space on the second side of the valve body. In this way, the valve body and the separating element separate the at least one space from an equalization region in which the portion of the equalization space is provided in the installed state of the base valve in the telescoping damper. Further, there is an exchange of fluid between the at least one space and the equalization region via at least one passage.

A base valve configured in this way has the advantage that when fluid is guided from the first side into the equalization region, i.e., in the installed state of the base valve, the fluid initially flows through the at least one space from the work chamber into the equalization space. This causes a gradual depressurization when the restricted fluid flowing out of the at least one restriction bore passes into the equalization region and ultimately results in a noise reduction. For, in this way, a gradual pressure reduction is brought about when fluid flows from the first side into the equalization region in that, in a first step, a pressure reduction takes place in the intermediate space immediately following the at least one restriction bore and, in a second step, a further pressure reduction takes place when fluid flows out of the intermediate space into the equalization region. As a result, noises in a telescoping damper can be reduced in the compression stage of the telescoping damper.

It is key that, as a result of defining the space between valve body and separating element and separating it from the equalization region, the achievement is brought about that fluid flowing via the at least one restriction bore must initially flow through the intermediate space before the fluid can reach the equalization region. The fluid can be enabled to pass on to the equalization region via the at least one passage.

The equalization region of the base valve is a region in which the portion of the equalization space below the base valve is located in the installed state of the base valve.

Exactly one intermediate space into which the at least one restriction bore opens is preferably defined between the valve body and the separating element. In the preferred embodiment form of the valve body in which a plurality of restriction bores are formed in the valve body, all of the restriction bores open into the exactly one intermediate space. However, it is also contemplated within the framework of the invention that when there are a plurality of restriction bores an associated space is defined in the region of the respective orifice of the individual restriction bore.

A respective exchange of fluid via the at least one passage can be permanently enabled within the framework of the invention so that fluid can constantly flow out of the at least one intermediate space into the equalization region. The gradual depressurization is then brought about in particular by a flow deflection. Alternatively, a respective exchange of fluid via the at least one passage can also be state-dependent. In this case, a flow of fluid out of the at least one intermediate space into the equalization region does not take place permanently but rather only in particular states, preferably particular flow ratios or particular pressure ratios between the at least one intermediate space and the equalization region.

According to an embodiment form of the invention, the separating element is fitted to the valve body on the second side thereof, and the at least one passage, as permanent passage, makes it possible for fluid to flow in each case out of the at least one intermediate space into the equalization region accompanied by a flow deflection of this fluid. In this way, a simple construction can advantageously be realized and, further, owing to the flow deflection, a gradual depressurization can be realized as fluid flows out into the equalization region.

In a further development of the aforementioned embodiment form, the separating element is pot-shaped and is inserted into a recess which is provided on the second side of the valve body and opens into the at least one restriction bore. This makes a compact construction of the base valve possible in that the pot-shaped separating element is inserted into a corresponding recess on the valve body side and, because of its pot-like shape, together with the valve body defines the intermediate space in the region of the respective orifice of the at least one restriction bore.

The pot-like separating element preferably has a hollow-cylindrical portion adjoined by a radially extending base portion. The separating element is held in the recess of the valve body, preferably pressed into the recess of the valve body, via the hollow-cylindrical portion. In a further development of this variant, the respective permanent passage is formed by an opening provided in the base portion of the separating element. The flow deflection is implemented in that the opening is radially recessed with respect to a respective flow-out direction of the fluid which is defined at the respective orifice of the at least one restriction bore. Accordingly, a suitable permanent passage from the at least one space into the equalization region can be provided, and a flow deflection of the fluid flowing via the opening is brought about. The opening is preferably formed centrally at the base portion. Further, an annular gap is formed particularly in the region of the opening in order, for one, to realize a sufficient delimitation of the at least one space from the equalization region and, therefore, to realize the gradual depressurization, but, on the other hand, to nevertheless form a permanent passage for fluid. Accordingly, this gap can be realized between the preferably central opening and a screw bolt of the base valve extending into the opening.

Alternatively or additionally, the respective permanent passage has a gap which is formed between the hollow-cylindrical portion and a base region of the recess of the valve body, and the gap forms a through-passage into a cutout provided radially outwardly of the hollow-cylindrical portion. The hollow-cylindrical portion brings about the flow deflection of fluid which flows into the gap and flows on into the recess. Accordingly, as an alternative to or in addition to the opening of the base portion, a suitable permanent passage from the at least one space into the equalization region can also be provided, and the flow deflection for bringing about the gradual depressurization is generated in the fluid routing via this permanent passage. In particular, the cutout is formed circumferentially and is axially limited via a fastening region or a pressing region at which the pot-like separating element is circumferentially held radially outwardly at the valve body. Further, a connection to at least one pocket which is provided for the valve body on the second side and connected to the equalization region can be produced in each instance by the cutout. This makes it possible for fluid guided into the cutout to flow further into the equalization region.

In a further variant of the invention, there is inserted in the separating element at least one bore hole via which only a respective fluid flow from the equalization region into the at least one intermediate space can be realized, whereas a respective opposite fluid flow from the intermediate space into the equalization region via the at least one bore hole is prevented. Accordingly, in a rebound stage of the telescoping damper, fluid can be sucked out of the equalization space into the intermediate space substantially unimpeded in order for the fluid to be guided subsequently to the work chamber of the telescoping damper. In particular, the opposite fluid flow is prevented via a cover disk which lies on the respective orifice of the at least one bore hole on the side of the at least one intermediate space. With the pot-like shape of the separating element, the at least one bore hole is then preferably formed in the base portion.

According to an alternative embodiment possibility of the invention, the separating element is provided as a further valve body which divides the at least one intermediate space on the second side of the valve body from the equalization region, the at least one passage being formed by a through-opening of the further valve body. Accordingly, in this possible configuration of the invention, there is provided in addition to the valve body a further valve body, and the two valve bodies enclose the at least one intermediate space therebetween. The valve body brings about a separation of this at least one space toward the first side in each instance, while the further valve body separates the at least one space from the equalization region. Accordingly, an extensive enclosure of the at least one intermediate space is possible so that the gradual depressurization can be achieved in a particularly efficient manner.

The valve body and the further valve body are particularly preferably designed to be at least extensively identical so that the production expenditure for realizing the base valve according to the invention can be reduced in that the two valve bodies are designed so as to be at least substantially identical parts. Within the meaning of the invention, “at least substantially” means that the two valve bodies differ from one another only minimally. Accordingly, the two valve bodies preferably differ at most only in respective attachment regions at which the valve bodies are attached to one another.

In a further development of the aforementioned embodiment possibility, the respective through-opening forming the at least one passage is a restriction bore of the further valve body which opens into the at least one intermediate space on the one hand and into the equalization region on the other hand. Accordingly, the at least one passage is configured as a restriction point through which it is possible for fluid to flow out of the at least one intermediate space into the equalization region and the gradual depressurization is realized.

Alternatively, but preferably additionally, at least one spring disk is arranged at a respective orifice of the respective through-opening of the further valve body in the equalization region, which spring disk resiliently contacts the further valve body at the respective orifice of the respective through-opening. The at least one spring disk allows fluid to flow out of the at least one intermediate space into the equalization region, but prevents fluid from flowing back into the at least one intermediate space via the respective through-opening. Preferably, only a few spring disks or even just one spring disk is provided in the equalization region at the respective orifice of the respective through-opening so as to offer the least possible resistance against the flow of fluid out of the at least one intermediate space into the equalization region. In particular, there is provided, in addition to the at least one spring disk, a captor washer against which the several spring disks or the exactly one spring disk can abut when fluid flows out into the equalization region. Further, in addition to the at least one spring disk, a pre-opening disk can be provided which enables a constant through-flow into the equalization region.

Further alternatively or additionally, the valve body and the further valve body are connected to one another via a hollow-cylindrical connection element. In this way, a suitable connection of the two valve bodies is realized and a preassembled base valve can accordingly easily be provided. Further, an additional enclosing of the at least one space can be realized by the connection element. The valve body is preferably held at a tube end of a work cylinder of the telescoping damper in an installed state of the base valve and is connected to the further valve body via the hollow-cylindrical connection element. The connection element is fitted, preferably pressed on, to a respective attachment portion particularly on the valve body side and on the further valve body side. However, it is also contemplated within the framework of the invention to form the hollow-cylindrical connection element integral with the valve body or further valve body.

In a further possible embodiment of the invention, the valve body is further provided with at least one bore hole which opens at the first side. A cover disk is placed at the respective orifice of the at least one bore hole, which cover disk covers the respective orifice when fluid flows from the first side to the equalization region and releases the respective orifice when fluid flows in the opposite direction from the equalization region to the first side. In this way, a flow of fluid from the equalization region to the first side can advantageously be possible. In a particularly preferable manner, the at least one bore hole opens into the at least one intermediate space in addition to the first side, and fluid can flow back from the equalization region into the at least one intermediate space virtually unimpeded. When, in addition to the valve body, the base valve has a further valve body, the further valve body is also outfitted in particular with at least one such bore hole and an associated cover disk.

In a further development of the invention, at least one spring disk is provided in each instance at a respective orifice of the at least one restriction bore of the valve body in the at least one intermediate space, this spring disk being resiliently supported at the valve body at the respective orifice of the at least one restriction bore. Accordingly, a restricted fluid flow can be provided in direction of the second side and a fluid flow in the opposite direction can be reliably prevented.

A subject matter of the invention is further a telescoping damper which is particularly a chassis vibration damper. This telescoping damper comprises at least one base valve according to one or more of the above-described variants. Within the meaning of the invention, a “chassis vibration damper” is a vibration damper which is provided for use in a chassis of a motor vehicle.

In particular, the telescoping damper has a work cylinder which is received in a reservoir tube and, together with the reservoir tube, defines an equalization space. To this extent, the telescoping damper is constructed as a twin-tube damper. A base valve according to the invention is received at the work cylinder and divides a work chamber of the work cylinder from the equalization space. A gradual depressurization is brought about by the base valve according to the invention in a compression stage of the telescoping damper when fluid is guided out of the work chamber into the equalization space and a noise reduction is therefore achieved. In particular, the fluid is oil.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Advantageous embodiment forms of the invention which are explained in the following are shown in the drawings.

FIG. 1 is a sectional view of a portion of a telescoping damper in the region of a base valve corresponding to a first embodiment form of the invention, shown in a compression stage of the telescoping damper;

FIG. 2 is a perspective view of the base valve from FIG. 1; and

FIGS. 3 and 4 are sectional views of a base valve according to a second possible embodiment of the invention.

### DETAILED DESCRIPTION OF THE DISCLOSED EMBODIMENTS

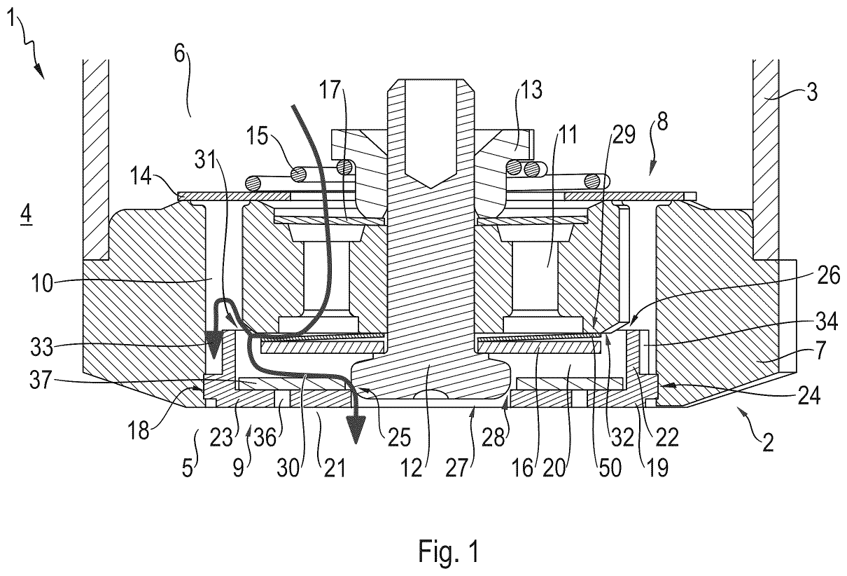

FIG. 1 shows a sectional view of a portion of a telescoping damper 1 which is, in particular, a chassis vibration damper. The telescoping damper 1 is shown in the region of a base valve 2 which is constructed corresponding to a first embodiment form of the invention and is arranged at one tube end of a work cylinder 3 of the telescoping damper 1. A piston, not presently visible in the depicted area, is displaceably guided in the work cylinder 3 in a manner known in principle to the person skilled in the art. The work cylinder 3 is surrounded by a reservoir tube, also not visible in FIG. 1, which, together with the work cylinder 3, defines an equalization space 4 arranged therebetween. This equalization space 4 is provided, for one, as an annular subspace radially surrounding the work cylinder 3 and, for another, as a portion 5 which is defined at the front side of the work cylinder 3.

The base valve 2 separates the equalization space 4 from a work chamber 6 which is defined inside of the work cylinder 2 and in which the piston is also displaceably guided and which is completely filled with a fluid in the form of oil. In contrast, equalization space 4 is filled partially with oil and partially with air or gas. Base valve 2 comprises a valve body 7 via which the equalization space 4 is separated from the work chamber 6. Work chamber 6 is situated on a first side 8 of valve body 7, while portion 5 of equalization space 4 is provided on a second side 9 of valve body 7. A plurality of bore holes 10 and a plurality of restriction bores 11 are inserted in valve body 7 and are configured, respectively, to extend axially in valve body 7. Both bore holes 10 and restriction bores 11 open out, respectively, at first side 8 of valve body 7 on the one hand and at second side 9 of valve body 7 on the other hand. Further, a screw bolt or a rivet 12 which is preloaded against valve body 7 via a nut 13 is axially guided through valve body 7.

A cover disk 14 which is preloaded against valve body 7 via a spring element 15 is provided at the orifices of bore holes 10 on first side 8 at valve body 7. Spring element 15 is supported at nut 13. In a rebound stage of telescoping damper 1, i.e., when telescoping damper 1 pulls apart, it is possible for oil to be sucked out of equalization space 4 into work chamber 6 via bore holes 10 in that cover disk 14 lifts at least partially from valve body 7 against the preloading generated by spring element 15 and accordingly releases the orifices of bore holes 10 on first side 8. Conversely, in a compression stage of telescoping damper 1, i.e., when telescoping damper 1 is pressed together, cover disk 14 covers the orifices of bore holes 10 on first side 8. Therefore, in this case, oil is prevented from flowing out of work chamber 6 into equalization space 4 via bore holes 10.

This displacement of oil from work chamber 6 into equalization space 4 in the compression stage of telescoping damper 1 is made possible via restriction bores 11, a plurality of spring disks 16 being provided at the orifices thereof on second side 9 of valve body 7. Spring disks 16 form a spring disk assembly and are together clamped in radially inward between valve body 7 and screw bolt or rivet 12. In addition, a pre-opening disk 50 is also placed between spring disks 16 and valve body 7. The flow of oil from work chamber 6 into equalization space 4 via restriction bores 11 is made possible as a result of spring disks 16 lifting from valve body 11 at radial outer sides of the spring disks 16, as a result of which orifices of restriction bores 11 are released on second side 9. In so doing, restriction bores 11 restrict the respective oil flow and accordingly generate a resistance against the flow of oil.

Before the oil enters the orifices of restriction bores 11 at first side 8 of valve body 7, a pre-restriction takes place in addition via a restriction disk 17 which is held radially inward at first side 8 of valve body 7 between valve body 7 and nut 13 and provided with a plurality of through bore holes. In contrast, in the rebound stage, spring disks 16 close the orifices of restriction bores 11 on second side 9 and accordingly prevent a flow of oil via restriction bores 11 in direction of first side 8.

Bore holes 10 and restriction bores 11 open out on second side 9 of valve body 7 into a recess 18 provided on second side 9 of valve body 7. Further, a pot-shaped separating element 19 which, together with valve body 7, encloses an intermediate space 20 is inserted in this recess 18. This intermediate space 20 encloses the orifices of restriction bores 11 situated on second side 9 and is delimited from an equalization region 21 in which portion 5 of equalization space 4 is defined. Accordingly, the oil guided via restriction bores 11 in direction of second side 9 initially flows into intermediate space 20.

In the present case, separating element 19 comprises a hollow-cylindrical portion 22 and, following thereon, a radially extending base portion 23 resulting in the pot-like shape of the separating element 19. The fastening of separating element 19 to valve body 7 is also effected at hollow-cylindrical portion 22 in that hollow-cylindrical portion 22 forms a circumferential pressing region 24 by which separating element 19 is pressed into recess 18 of valve body 7.

In order to allow oil that has arrived in space 20 to flow out into equalization region 21 and therefore also into equalization space 4, passages 25 and 26 are realized in base valve 2 via which, in each instance, a permanent exchange of oil can take place between space 20 and equalization region 21. Passage 25 is formed by an opening 27 which centrally penetrates base portion 23 and into which screw bolt 12 projects axially. Accordingly, passage 25 is defined as an annular gap 28, this gap 28 being formed so as to be offset radially inward with respect to an annular valve seat 29 formed for spring disks 16 at valve body 7. Accordingly, gap 28 is radially recessed with respect to flow-out directions in which the oil flows out of restriction bores 11 into space 20, as a result of which the oil must undergo a flow deflection in order to continue to flow out via gap 28. This is indicated in FIG. 1 by way of example by arrows 30 which represent a partial flow of an oil flow guided via one of restriction bores 11.

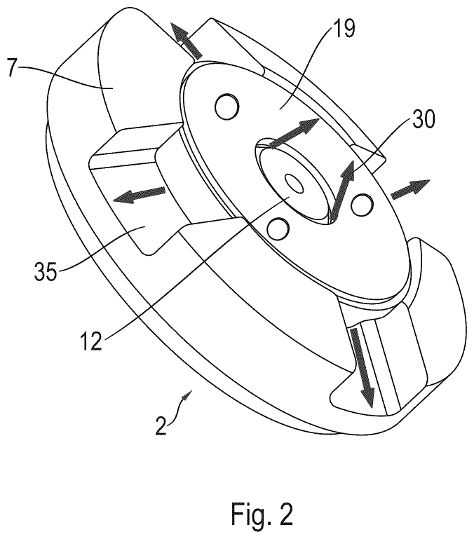

Passage 26 initially has an annular gap 31 which is defined by hollow-cylindrical portion 22 of separating element 19 together with a base region 32 of recess 18. In so doing, gap 31 is then also formed to radially overlap with the orifices of bore holes 10 on second side 9. As is illustrated by a further arrow 33 in FIG. 1, a further partial flow of oil represented by arrow 33 is deflected into a circumferential cutout 34 after flowing out via gap 31, hollow-cylindrical portion 22 being provided with this circumferential cutout 34 radially outwardly and axially adjoining pressing region 24. This flow deflection is carried out because the oil is additionally retained in bore holes 10 via cover disk 14 which lies on the orifices of bore holes 10. Thereafter, the oil that has flowed into cutout 34 can then arrive in equalization space 4 via pockets 35 which are formed lateral to separating element 19 on second side 9 of valve body 7. In the present case, pockets 35 are visible in FIG. 2 which shows a perspective isolated view of base valve 2.

Because of these flow deflections, a gradual depressurization is brought about in the compression stage of telescoping damper 1 when oil is guided out of work chamber 6 into equalization space 4, and a noise reduction is achieved as a result.

Further, as is also shown in FIG. 1, bore holes 36 are introduced in base portion 23 of separating element 19. Bore holes 36 respectively connect equalization region 21, and therefore equalization space 4, to space 20. A cover disk 37 is provided on the space 20 side. Cover disk 37 prevents oil from flowing out of space 20 via bore holes 36 into equalization region 21 by covering bore holes 36. On the other hand, when there is a flow of oil from equalization region 21 into space 20, cover disk 37 lifts from bore holes 36 to facilitate the oil being sucked back into work chamber 6 via bore holes 10 in the rebound stage of telescoping damper 1.

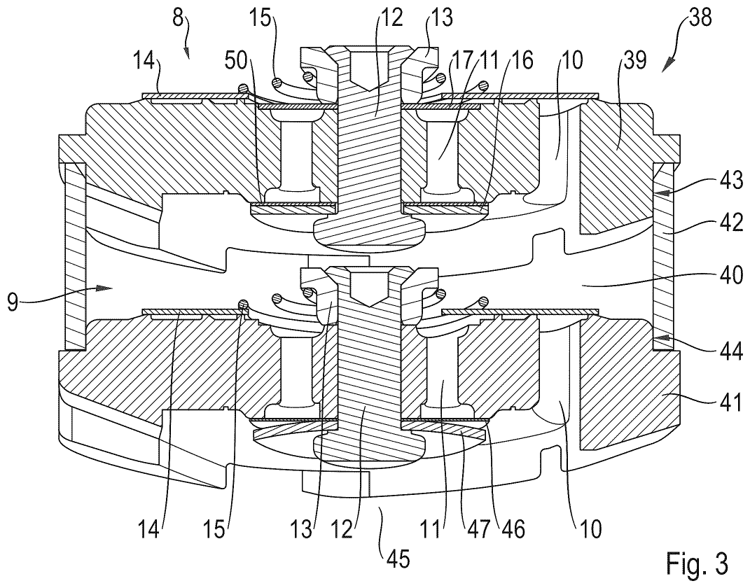

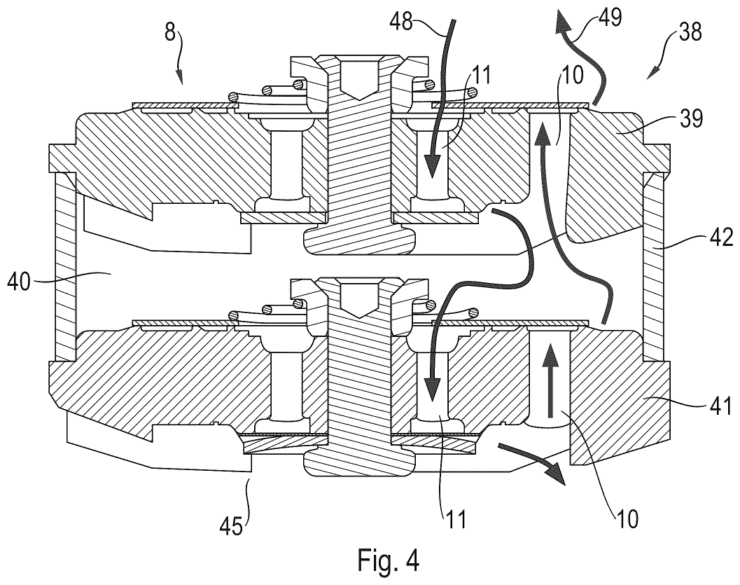

FIGS. 3 and 4 show sectional views of a base valve 38 which is constructed according to a second possible embodiment of the invention and which can be used as an alternative to base valve 2 in telescoping damper 1. Base valve 38 corresponds to base valve 2 from FIGS. 1 and 2 insofar as, in this case, there is also provided a valve body 39 through which a work chamber of a work cylinder situated on first side 8 can be separated from a portion of an equalization space situated on second side 9. Further, as in the variant according to FIGS. 1 and 2, valve body 39 of base valve 38 is provided with bore holes 10 and restriction bores 11. Again as in the variant according to FIGS. 1 and 2, there is a cover disk 14, a restriction disk 17, a spring element 15, a screw bolt 12 with nut 13, and spring disks 16 at valve body 39. With respect to these similarities and the manner of functioning, reference is made to the descriptions in FIGS. 1 and 2.

A space 40 is likewise enclosed on second side 9 of valve body 39, but in the variant according to FIGS. 3 and 4 this occurs between valve body 39 and a separating element in the form of a further valve body 41. In this case, valve body 39 and valve body 41 enclose space 40 together with a hollow-cylindrical connection element 42 via which valve bodies 39 and 41 are attached to one another. Connection element 42 is fitted to, preferably pressed on, an attachment portion 43 toward valve body 39 and an attachment portion 44 toward valve body 41.

Apart from the divergent shape in the region of attachment portions 43 and 44, valve body 41 is identical to valve body 39 and accordingly likewise has bore holes 10 and restriction bores 11. Moreover, valve body 41 is also penetrated by a screw bolt 12 which is preloaded against valve body 41 via a nut 13. A spring element 15 is supported at nut 13, a cover disk 14 being preloaded against valve body 41 on the space 40 side by this spring element 15.

Space 40 is separated from an equalization region 45 by valve body 41, the portion of the equalization space being situated in this equalization region 45 in the installed state of the base valve 38. In so doing, oil which has arrived in space 40 can flow out further into equalization region 45 via passages in the form of restriction bores 11 of valve body 41. A spring disk 46 is provided at orifices of restriction bores 11 of valve body 41 toward equalization region 45, which spring disk 46 is held together with a captor washer 47 radially inward between screw bolt or rivet 12 and valve body 41. A pre-opening disk can also be arranged between spring disk 46 and valve body 41. Spring disk 46 and the pre-opening disk which is possibly additionally installed can then contact captor washer 47 when oil is guided out of space 40 into equalization region 45 via restriction bores 11.

As a result of space 40 being enclosed between valve bodies 39 and 41, there is also a gradual depressurization in a compression stage of a telescoping damper when oil is guided from first side 8 of valve body 39, and therefore from the work chamber situated there, to equalization region 45 and, therefore, to the equalization space situated there. This is because, in the compression stage, the oil is initially directed into space 40 via restriction bores 11 of valve body 39 accompanied by restriction, and the oil can then flow out of space 40 into equalization region 45 via restriction bores 11 of valve body 41 accompanied by reduced restriction. This is indicated by arrows 48 in FIG. 4. Conversely, in a rebound stage of the telescoping damper, oil can be sucked out of equalization region 45, and therefore from the equalization space located there, via bore holes 10 of valve bodies 39 and 41 to first side 8 of valve body 39 and, therefore, to the work chamber located there, as is indicated in FIG. 4 by arrows 49.

When a telescoping damper is used, a base valve via which a noise reduction can be achieved in a compression stage of the telescoping damper can be provided by the embodiments according to the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A bottom valve for a telescoping damper comprising of a valve body with a first side and a second side and configured, in an installed state of the base valve, to separate a work chamber of the telescoping damper located on the first side from a portion of an equalization space of the telescoping damper located on the second side, wherein at least one restriction bore is formed in the valve body via which only a respective fluid flow from the first side of the valve body in a direction of the second side can be enabled, while a respective opposite fluid flow via the at least one restriction bore is prevented, and wherein a separating element is provided which, jointly with the valve body, defines at least one intermediate space, wherein the at least one intermediate space is bounded at least at a respective orifice of the at least one restriction bore facing the second side of the valve body and is delimited from an equalization region in which the portion of the equalization space is provided in the installed state of the base valve in the telescoping damper, and wherein fluid is exchangeable via at least one passage between the at least one intermediate space and the equalization region.

2. The bottom valve according to claim 1, wherein the separating element is fitted to the valve body on the second side thereof, wherein the at least one passage, as permanent passage in each instance, makes it possible for fluid to flow in each case out of the at least one intermediate space into the equalization region accompanied by a flow deflection of this fluid.

3. The bottom valve according to claim 2, wherein the separating element is pot-shaped and is inserted into a recess which is provided on the second side of the valve body and opens into the at least one restriction bore.

4. The bottom valve according to claim 3, wherein the pot-like separating element has a hollow-cylindrical portion adjoined by a radially extending base portion, wherein the separating element is held in the recess of the valve body via the hollow-cylindrical portion.

5. The bottom valve according to claim 4, wherein a permanent passage is formed in each instance by an opening provided in the base portion of the separating element, wherein the flow deflection is implemented in that the opening is radially recessed with respect to a respective flow-out direction of the fluid which is defined at the respective orifice of the at least one restriction bore.

6. The bottom valve according to claim 4, wherein the in each instance one permanent passage has a gap which is formed between the hollow-cylindrical portion and a base region of the recess of the valve body, wherein the gap forms a through-passage into a cutout provided radially outwardly of the hollow-cylindrical portion, wherein the hollow-cylindrical portion brings about the flow deflection of fluid which flows into the gap and flows on into the recess.

7. The bottom valve according to claim 6, wherein a connection to at least one pocket is produced via the cutout, the valve body being provided with the pocket on the second side, and the pocket is connected to the equalization region.

8. The bottom valve according to claim 2, wherein there is inserted in the separating element at least one bore hole via which only a respective fluid flow from the equalization region into the at least one intermediate space can be realized, whereas a respective opposite fluid flow from the at least one intermediate space into the equalization region via the at least one bore hole is prevented.

9. The bottom valve according to claim 1, wherein the separating element is provided as a further valve body which divides the at least one intermediate space on the second side of the valve body from the equalization region, wherein in each instance a through-opening in the further valve body formed the at least one passage.

10. The bottom valve according to claim 9, wherein the valve body and the further valve body are designed to be at least extensively identical.

11. The bottom valve according to claim 9, wherein the respective through-opening forming the at least one passage is a restriction bore of the further valve body which opens into the at least one intermediate space on the one hand and into the equalization region on the other hand.

12. The bottom valve according to claim 9, wherein at least one spring disk is arranged at a respective orifice of the respective through-opening of the further valve body in the equalization region, which spring disk resiliently contacts the further valve body at the respective orifice of the respective through-opening.

13. The bottom valve according to claim 9, wherein the valve body and the further valve body are connected to one another via a hollow-cylindrical connection element.

14. The bottom valve according to claim 1, wherein the valve body is further provided with at least one bore hole which opens at the first side, wherein a cover disk is placed at the respective orifice of the at least one bore hole at the first side of the valve body, which cover disk covers the respective orifice when fluid flows from the first side to the equalization region and releases the respective orifice when fluid flows in the opposite direction from the equalization region to the first side.

15. The bottom valve according claim 1, wherein at least one spring disk is provided at the respective orifice of the at least one restriction bore of the valve body in the at least one intermediate space, which spring disk is resiliently supported at the valve body in each instance at the respective orifice of the at least one restriction bore.

16. A telescoping damper, comprising a base valve according to claim 1.

17. The bottom valve of claim 4, wherein the separating element is pressed into the recess of the valve body via the hollow-cylindrical portion.
